(19) United States
(12) Patent Application Publication
(10) Pub. No.: US 2012/0015548 A1
(43) Pub. Date: Jan. 19, 2012

(54) Electronic apparatus equipped with connectors

(75) Inventor: Keiji Kurakagi, Kawasaki (JP)

(73) Assignee: FUJITSU LIMITED, Kawasaki (JP)

(21) Appl. No.: 13/137,872

(22) Filed: Sep. 20, 2011

Related U.S. Application Data
(63) Continuation of application No. PCT/JP2009/056481, filed on Mar. 30, 2009.

(51) Int. Cl. H01R 13/64

(52) U.S. Cl. 439/374

(57) ABSTRACT

An electronic apparatus includes a connector provided to a surface of a housing; and a guide part configured to guide a connection connector, which is to be connected to the connector, to a connecting position. The guide part includes a pair of width direction guide surfaces and a height direction guide surface. The width direction guide surfaces guide the connection connector to the connecting position with respect to a direction of width of the connector by sandwiching the connection connector therebetween in the direction of width. The height direction guide surface guides the connection connector to the connecting position with respect to a direction of height of the connector in a state where the connection connector is in contact with the height direction guide surface.

### CROSS-REFERENCE TO RELATED APPLICATIONS

This application is a U.S. continuation application, filed under 35 USC 111(a) and claiming the benefit under 35 USC 120 and 365(c), of PCT application JP2009/056481 filed Mar. 30, 2009. The foregoing application is hereby incorporated herein by reference.

### FIELD

The embodiment discussed herein is directed to an electronic apparatus equipped with connectors.

### BACKGROUND

For example, an electronic apparatus such as a monitor device used as a display device of a computer or a video device is equipped with connectors (connector terminals) for connecting a power supply cable, a data communication cable and the like in many cases. Usually, a monitor device serving as a display device is equipped with a plurality of connectors, such as a power supply connector, a data line connector for inputting display image data, an audio input line connector, an audio output line connector, a video output line connector, etc.

Because a front face of the monitor device serves as an image display part such as a liquid-crystal display device, many connectors are provided on a rear face or a side face of the monitor device. For example, Japanese Laid-Open Patent Application No. 2006-202817 discloses a housing of a monitor device having a rear face provided with a recessed portion so that a downwardly-facing face is formed and a plurality of connectors are provided on the downwardly-facing surface. There may be a case where a housing of a monitor device has a laterally-facing face provided with a recessed portion so that the laterally-facing face is formed and a plurality of connectors are provided on the laterally-facing surface.

In order to connect a connection line to the above-mentioned connector of the monitor device, a connector of a connection line must be inserted into the connector of the monitor device after checking the position of the connector of the monitor device and aligning the connector of the connection line with the connector of the monitor device. If the connector is provided on a rear face of a housing of the monitor device, which is an example of an electronic apparatus, a person who is connecting a line must check the position of the connector of the monitor device while looking into the rear face of the monitor device. Moreover, if the connector is provided on a downwardly-facing face on the rear face, the person must visually recognize the connector while looking into the rear side from a lower side. In such a case, the person who is connecting the connection line attempts to insert the connector of the connection line into the connector of the monitor device after merely recognizing an approximate position of the connector of the monitor device. Usually, many pins are provided in the connector of the connection line or the connector of the monitor device, and one of the connectors making a pair is connected to the other of the connectors by inserting the pins of the one of the connectors into pin holes of the other of the connectors. If a person attempts to insert the one of the connectors into the other of the connectors while merely recognizing an approximate position of the other of the connectors, the pins of the one of the connectors may be obliquely inserted into the pin holes of the other of the connectors in a state where the pins are not accurately aligned with the pin holes. In such a case, there may be a problem in that an undesired force is applied to the pins which results in bending the pins.

Moreover, there may be a case where it is difficult to check the position of the connector because a plurality of connectors having similar shapes are provided on a rear face of a housing of a monitor device in many cases. If an attempt is made to connect a connector to a connector having a different terminal configuration, there also may be a problem in that an undesired force is applied to the pins which results in bending the pins.

Such a problem can be avoided if a connector of a connection line can be connected to a connector of an electronic apparatus by merely checking an approximate position of the connector of the electronic apparatus without recognizing an accurate position of the connector of the electronic apparatus.

### SUMMARY

According to an aspect of the invention, an electronic apparatus equipped with a connector, includes: the connector provided to a surface of a housing; and a guide part configured to guide a connection connector, which is to be connected to the connector, to a connecting position, wherein the guide part includes a pair of width direction guide surfaces and a height direction guide surface, the width direction guide surfaces guiding the connection connector to the connecting position with respect to a direction of width of the connector by sandwiching the connection connector therebetween in the direction of width, the height direction guide surface guiding the connection connector to the connecting position with respect to a direction of height of the connector in a state where the connection connector is in contact with the height direction guide surface.

The object and advantages of the embodiment will be realized and attained by means of the elements and combinations particularly pointed out in the appended claims.

It is to be understood that both the foregoing general description and the following detailed description are exemplary explanatory only and are not restrictive of the invention, as claimed.

### BRIEF DESCRIPTION OF DRAWINGS

FIG. 1 is a perspective view of a monitor device according to a first embodiment, viewed from a rear-face side;

FIG. 2 is a view of a part where connectors are provided;

FIG. 3 is a cross-sectional view taken along a line of FIG. 2;

FIG. 4 is a view indicating a variation of a guide mold illustrated in FIG. 2;

FIG. 5 is a view indicating a variation of a raised part illustrated in FIG. 2;

FIG. 6 is a view indicating a variation of a protruding part illustrated in FIG. 2;

FIG. 7 is a cross-sectional view taken along a line VI-VI of FIG. 6;

FIG. 8 is a view indicating a guide part according to a second embodiment;

FIG. 9 is a cross-sectional view taken along a line IX-IX of FIG. 8;

FIG. 10 is a view illustrating a state connection connectors are connected to the respective connectors illustrated in FIG. 2;

FIG. 11 is a view of connector provided on a side face of a monitor device;

FIG. 12A is a view indicating a shape of a guide protruding part

FIG. 12B is a view indicating another shape of the guide protruding part;

FIG. 12C is a view indicating a further shape of the guide protruding part;

FIG. 13 is a cross-sectional view of a mark part formed by concave parts;

FIG. 14 is a cross-sectional view of a mark part formed by convex parts;

FIG. 15 is a view of a mark part using a connector identification icon;

FIG. 16 is a view of a mark part using a simple shape;

FIG. 17 is a view of a mark part to identify a type of a connector according to a number of circles;

FIG. 18A is a cross-sectional view of a part indicating the circles by concave parts;

FIG. 18B is a cross-sectional view of a part indicating the circles by convex parts;

FIG. 19 is a view of a mark part to identify a type of a connector according to a number of squares;

FIG. 20A is a cross-sectional view of a part indicating the squares by concave parts;

FIG. 20B is a cross-sectional view of a part indicating the squares by convex parts; and

FIG. 21 is a view of a mark part to identify a type of a connector according to Braille.

### DESCRIPTION OF EMBODIMENT(S)

Preferred embodiment of the present invention will be explained with reference to the accompanying drawings.

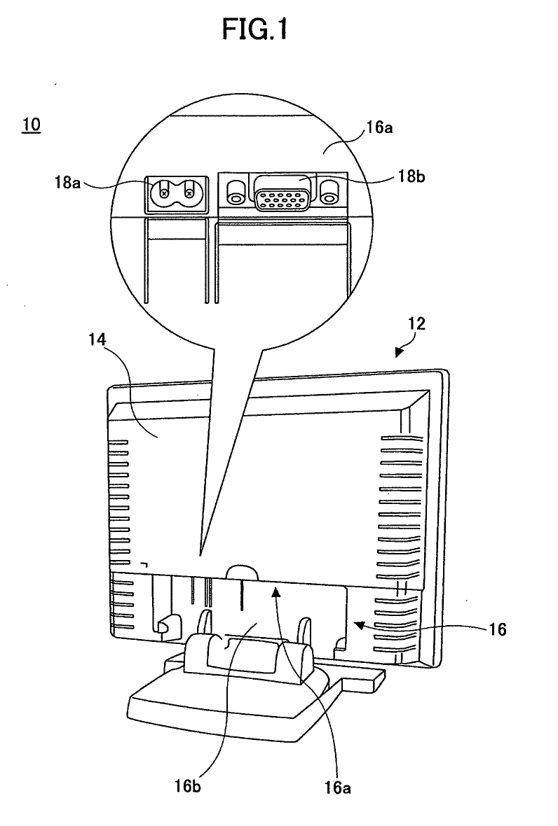

FIG. 1 is a perspective view of a monitor device according to a first embodiment, viewed from a rear-face side. The monitor device illustrated in FIG. 1 is an example of an electronic apparatus equipped with connectors, and is a liquid-crystal display device serving as a display apparatus of a personal computer.

A concave part 16 is formed in a rear face 14 of a housing 12 of the monitor device 10, and a plurality of connectors are exposed from a downward-facing surface 16a, which faces in a downward direction in an upper part of the concave part 16. FIG. 1 illustrates an enlarged view of a portion of the downward-facing surface 16a. A power supply line connector 18a and a display signal input line connector 18b are illustrated in the enlarged view.

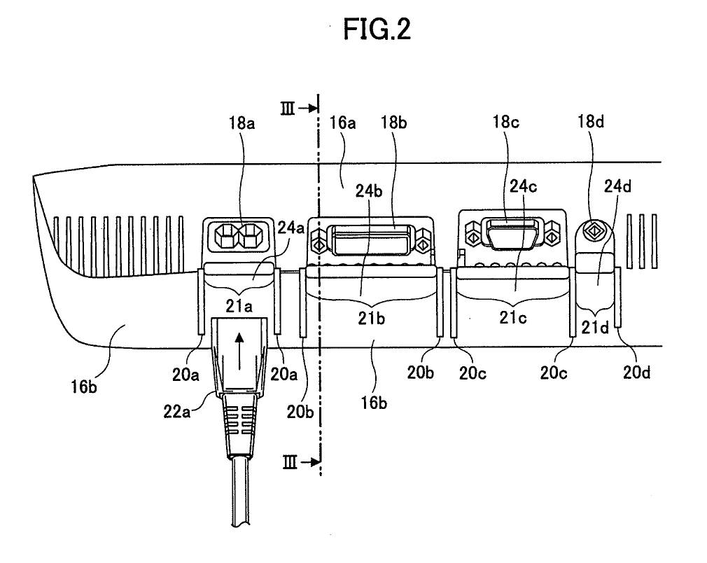

FIG. 2 is a view of a part of the concave part 16 where connectors 18a, 18b, 18c and 18d are provided. As illustrated in FIG. 2, the downward-facing surface 16a of the concave part 16 is provided with the video display signal input line connector 18c and the audio signal input line connector 18d besides the power supply line connector 18a and the data signal input line connector 18b. The connectors 18a, 18b, 18c and 18d have different shapes and different number of pins.

The operation to connect connectors to the respective connectors 18a, 18b, 18c and 18d must be performed while checking positions of the connectors 18a, 18b, 18c and 18d by looking into the downward-facing surface 16a, which operation is inconvenient and difficult to do by an operator. Thus, according to the present embodiment, as illustrated in FIG. 2, guide molds 20a, 20b, 20c and 20d are formed in the positions corresponding to connectors 18a, 18b, 18c and 18d as guide projection parts on the bottom surface 16b of the concave part 16.

The guide molds 20a, 20b, 20c and 20d, which serve as guide projection parts, are rib-shaped projections integrally formed on the surface of the housing 12, which is formed as a plastic mold product. The guide molds 20a, 20b, 20c and 20d guide the connection connectors to be inserted into the connectors 18a, 18b, 18c and 18d, respectively, so as to accurately lead the connectors to the connecting positions of the connectors 18a, 18b, 18c and 18d, respectively.

A description is given below of a guide function of the guide molds 20a, 20b, 20c and 20d with reference to the guide molds 20a as an example. Two guide molds 20a are provided at positions corresponding to both sides of the connector 18a. A width Dl between the two guide molds 20a is slightly larger than a width of the connection connector 22a to be inserted into the connector 18a. By placing the connection connector 22a, which is to be inserted into the connector 18a, between the two guide molds 20a and moving the connection connector 22a toward the connector 18a, the connection connector 22a moves in a space between the two guide molds 20a and is accurately lead to the connecting position with the connector 18a.

Although there is no limitation in the height of the guide molds 20a, which are guide projection parts projecting from the bottom surface 16b of the concave part 16, it is desirable to set the height of the guide molds 20a to a level such that guide molds 20a can guide the connection connector 22a. If the height of the guide molds 20a is too high, an operation of catching the connection connector 22a by fingers and pushing it into the connector 20a is difficult to do. Accordingly, it is desirable to set the height of the guide molds 20a projecting from the bottom surface 16b to a level such that, when the connection connector 22a is placed between the guide molds 22a and pressed against the bottom surface 16b, the fingers can touch opposite side surfaces of the connector 22a to catch the connector 22a.

The guide function according to the above-mentioned pair of guide molds 20a is a guide function with respect to a direction of width of the connection connector 22a. Thus, in order to provide a guiding function with respect to the direction of thickness or the height of the connection connector 22a (a direction perpendicular to the paper surface of FIG. 2) , a raised portion 24a is provided on the bottom surface 16b of the concave part 16. Similarly, raised portions 24b, 24c and 24d are provided with respect to the connectors 18b, 18c and 18d. The raised portions 24a, 24b, 24c and 24d are protruding portions formed by partially raising the bottom surface 16b of the concave part 16, and are formed at positions in front of the connectors 18a, 18b, 18c and 18d, respectively.

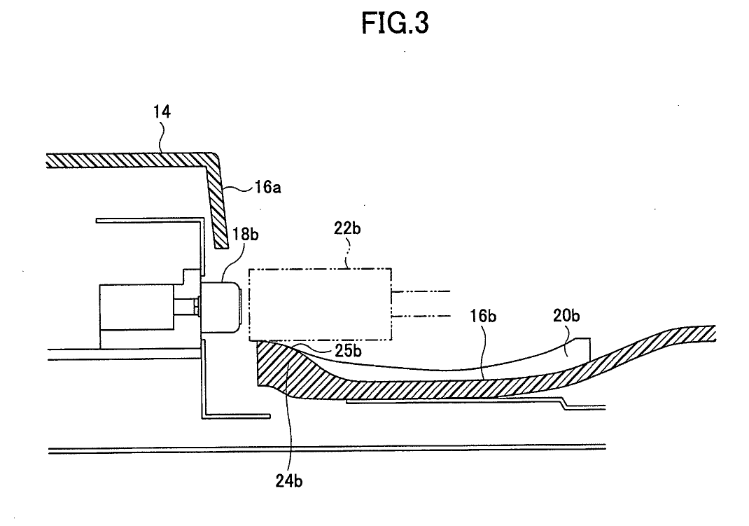

A description is given below of a guiding function of the raised portions 24a, 24b, 24c and 24d with reference to the raised portion 24b as an example. FIG. 3 is a cross-sectional view taken along a line of FIG. 2.

The raised portion 24b is a portion raised from the bottom surface 16b of the concave part 16 at a position in front of the connector 18b illustrated in FIG. 3. An upper surface (surface) 25b of the raised portion 24b serves as a height direction guide surface which guides the connection connector 22b to be lifted from the bottom surface 16b of the concave part 16 so that the connection connector 22b is positioned at a height of the connector 18b. That is, when the connection connector 22b is moved from a position slightly remote from the connector 18b toward the connector face 10b by causing the connection connector 22b to slide on the bottom surface 16b, the connection connector 22b overrides the upper surface 25b of the raised portion 24b at a position close to the connector 18b, and, finally, the connection connector 22b is set at a height (position) the same as the connector 18b. At this time, because the connection connector 22b is guided with respect to the direction of width by the guide molds 20b, the connection connector 22b is guided both in the direction of width and the direction of height (direction of thickness), and is accurately lead to the connecting position with the connector 18b.

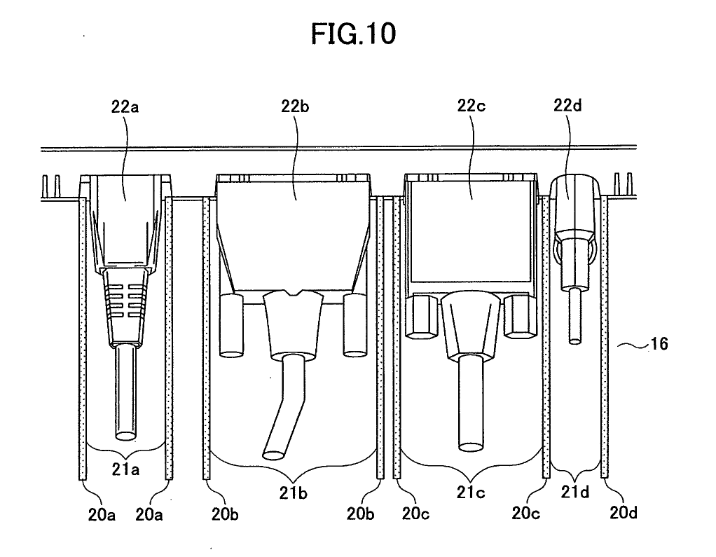

It should be noted that because the connector 18c and the connector 18d are close to each other, there is no space to provide two guide molds between the connector 18c and the connector 18d. Thus, only one guide mold 20c is provided between the connector 18c and the connector 18d. The guide mold 20c makes a pair with another guide mold 20c located on opposite side so as to serve as a guide of the connection connector 22c being connected to the connector 18c (refer to FIG. 10). Additionally, the guide mold 20c makes a pair with a guide mold 20d so as to serve as a guide of the connection connector 22d to be connected to the connector 18d (refer to FIG. 10).

As mentioned above, according to the present embodiment, the connection connectors 22a, 22b, 22c and 22d being connected to the connectors 18a, 18b, 18c and 18d are lead to the respective connecting positions by providing the guide molds 20a, 20b, 20c and 20d and the raised portions 24a, 24b, 24c and 24d, which provides guide surfaces, on the rear surface of the housing 12 of the monitor device 10. Accordingly, the connection connectors 22a, 22b, 22c and 22d can be accurately guided to the connecting positions by merely placing and moving the connection connectors 22a, 22b, 22c and 22d between the corresponding pairs of the guide molds 20a, 20b, 20c and 20d, thereby avoiding a problem such as bending of pins due to forced insertion with misalignment. Because the guide molds 20a, 20b, 20c and 20d and the raised portions 24a, 24b, 24c and 24d are integrally formed with the plastic mold housing 12 so as to be portions of the housing 12, there is no need to add any special parts that provide a guide function, thereby avoiding an increase in the manufacturing cost of the monitor device 10.

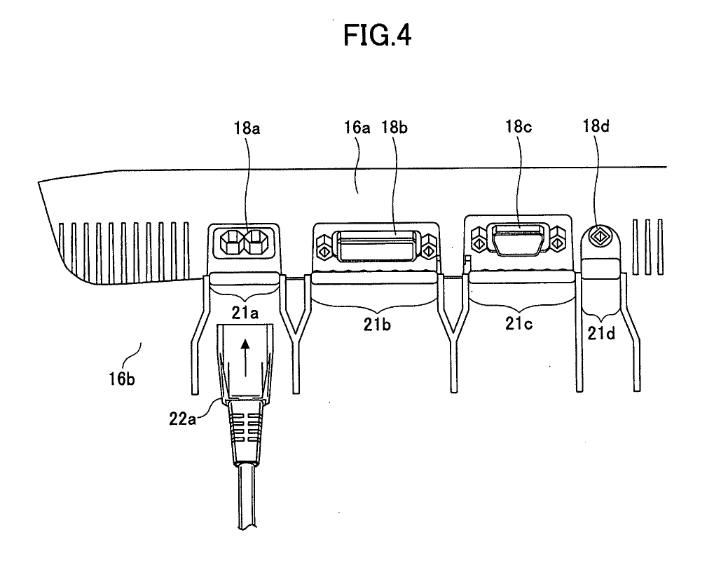

In the present embodiment, a distance between a pair of guide molds is set slightly larger than the corresponding connection connector. However, the distance between the pair of guide molds may be set larger at a position remote from the connector and gradually reduced as it goes close to the connector so that the distance becomes slightly larger than the width of the connector at a position slightly before the connecting position at which the connection connector is connected to the connector. FIG. 4 illustrates such pairs of guide molds.

In FIG. 4, the distance between the pair of guide molds 20a is gradually reduced as it goes closer to the connector 18a so that the distance is slightly larger than the width of the connection connector 22a at a position close to the connector 18a. Therefore, the connection connector 22a can be easily positioned relative to the connector 18a by first placing the connection connector 22a in a portion where the distance between the pair of guide molds 20a is large and, then, moving the connection connector 22a toward the connector 18a. That is, a freedom of position at which the connection connector 22a is placed first is increased.

Therefore, even in a case where the guide molds 20a cannot be recognized visually, an approximate position at which the connection connector 22a is placed can be recognized by touching the rear surface 14 of the housing 12 by fingers and, thereafter, the connection connector 22a can be placed at that position. Thereby, the connection connector 22a can be placed between the pair of guide molds 20a. Although the position at which the connection connector 22a is placed can be recognized by finger touch even in the case where the guide molds 20a have a linear shape such as illustrated in FIG. 2, the connection connector 22a can be more easily placed without visual recognition of the guide molds 20a when the connection connector 22a is placed at a portion where the distance between the pair of guide molds 20a is larger.

It should be noted that, in the example illustrated in FIG. 4, the guide mold 20a and the guide mold 20b adjacent to the guide mold 20a are merged at a portion where the distance between the guide molds 20a is large. Accordingly, the guide mold positioned between the connector 18a and the connector 18b has a single base portion and the base portion on the side close to the connectors 18a and 18b is bifurcated into two portions, which correspond to the guide mold 20a and the guide mold 20b.

In the example illustrated in FIG. 4, the above-mentioned structure of the guide mold 20a is applied to other guide molds 20b, 20c and 20d.

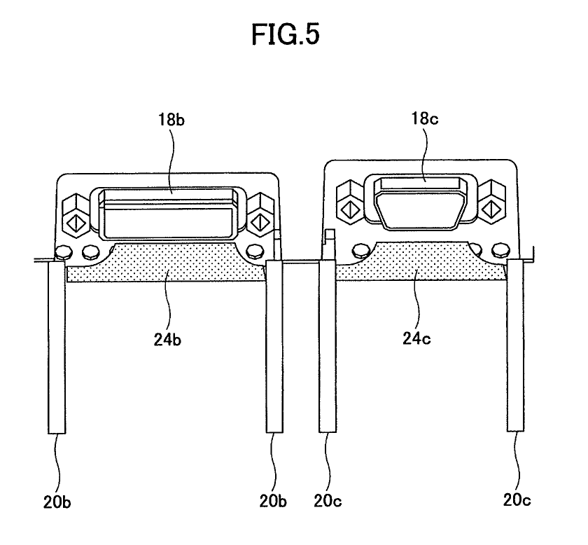

FIG. 5 is a view illustrating a variation of the raised portions 24b and 24c. The connection connectors 22b and 22c connected to the connectors 18b and 18c have screws for fixation, respectively, so that the connection connectors 22b and 22c can be fixed in a connected state by screwing the fixing screws into screw holes provided on both sides of each of the connectors 18b and 18c. Therefore, an operation of turning the fixing screws must be performed after connecting the connection connectors 22b and 22c to the connectors 18b and 18c.

The operation to turn the fixing screws on both sides after the connection is an action to turn the fixing screws while pinching the fixing screws by fingers. Accordingly, if the raised portions 24b and 24c extend to near the fixing screws, the raised portions 24b and 24c may prevent the operation to turn the fixing screws by fingers. Thus, in the example illustrated in FIG. 5, both sides of each of the raised portions 24b and 24c are removed. The both sides of each of the raised portions 24b and 24c are not actually removed but the raised portions 24b and 24c are formed initially with such a shape with both sides removed. Thereby, the fixing screws can be turned easily by fingers without the fingers contacting the raised portions 24b and 24c.

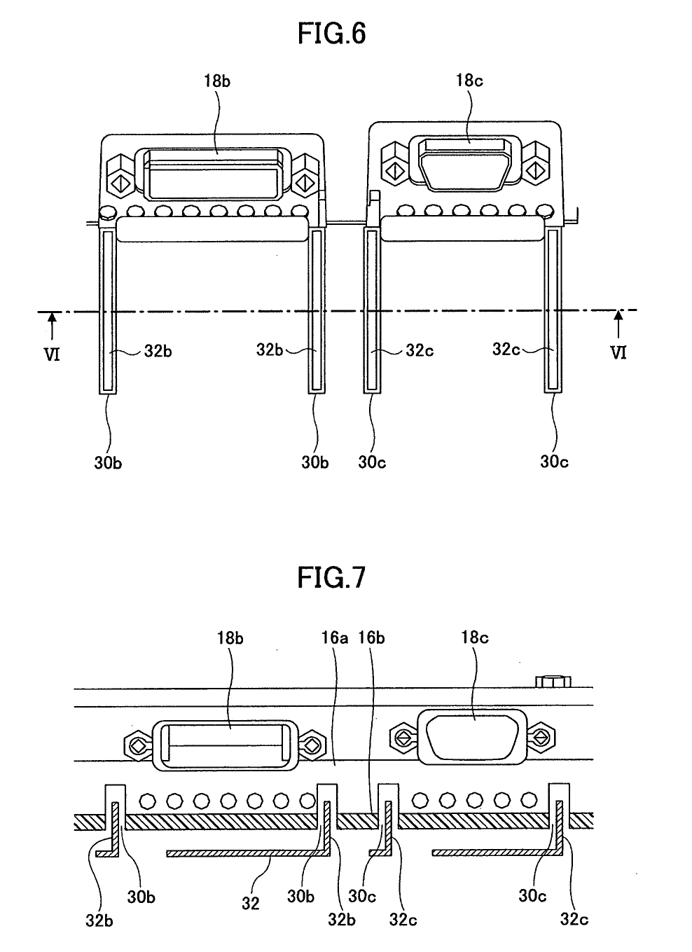

Although the guide projection part, which provides the guide function in the direction of width, corresponds to the guide mold formed in the housing 12 in the present embodiment, the guide projection part providing the guide function may be formed by cutting and raising a metal part of a chassis or the like in the housing 12 and causing the thus-formed metal cut portion to pierce the housing 12 as illustrated in FIGS. 6 and 7.

As illustrated in FIG. 6, slits 30b and 30c are formed in the bottom surface 16b of the concave part 16 of the housing 12 at positions where the guide olds 20b and 20c are to be provided. Then, as illustrated in FIG. 7, portions of a metal plate part 32 provided inside the bottom surface 16b are cut and raised to form metal plate guide parts, which penetrate through the slits 30b and 30c and extend to outside the housing 12. The side surfaces of the metal plate guide parts 32b and 32c extending outside the housing 12 provide the guide function as the side surfaces 21b and 21c of the above-mentioned guide molds 20b and 20c.

When the metal plate part 32 in which the metal plate guide parts 32b and 32c are formed is grounded, electric charges accumulated in the connection connectors 22b and 22a and in tips of fingers are discharged to the metal plate part. Thereby, a discharge from the connection connectors 22b and 22c can be prevented when connecting the connection connectors 22b and 22c to the connectors 18b and 18c. It should be noted that although the metal plate guide parts 32b and 32c provided to the connectors 18b and 18c having a relatively large width are illustrated in FIG. 6 and FIG. 7, slits and metal plate guide parts may be provided instead of the guide molds similar to other connectors 18a and 18d.

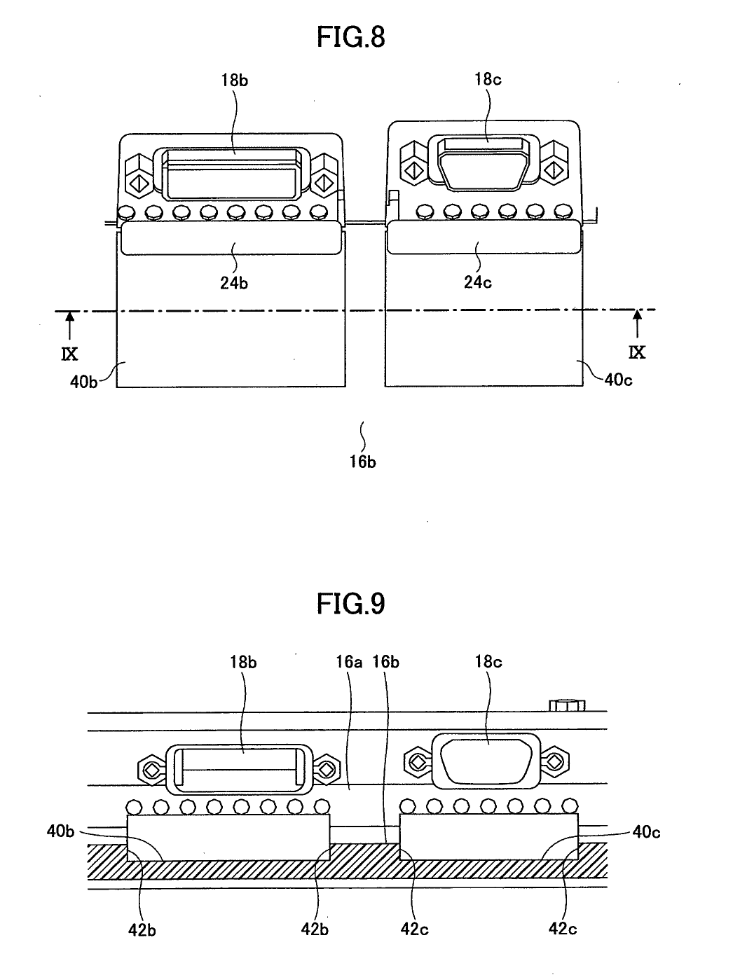

A description will be given, with reference to FIG. 8 and FIG. 9, of a second embodiment. In the second embodiment, instead of providing guide function to the projection part as in the first embodiment, guide grooves or guide concave parts 40b and 40c are formed on the bottom surface 16b in order to guide the connection connectors.

The widths of the guide concave parts 40b and 40c is slightly larger than the widths of the connection connectors 22b and 22c, respectively, in order to guide the connection connectors 22b and 22c. That is, the both side surfaces of each of the guide concave parts 40b and 40c serve as width direction guide surfaces to guide the movement of the connection connectors 22b and 22c in a direction toward the connectors 18b and 18c.

Moreover, similar to the height of the guide molds, it is desirable that the depth of the guide concave parts 40b and 40c is set to a depth so that the connection connectors 40b and 40c can be pinched by fingers by contacting the fingers with the both side surfaces of each of the connection connectors 22b and 22c when the connection connectors 22b and 22c are placed inside the guide concave parts 40b and 40c and pressed against the bottom surface of the guide concave parts 40a and 40c, respectively.

Also in the present embodiment, similar to the first embodiment, the raised portions 24b and 24c are provided to provide the guide function with respect to the direction of thickness of the connection connectors 22b and 22c (in a direction perpendicular to the paper surface of FIG. 8).

Although FIG. 8 and FIG. 9 illustrate providing the guide concave parts 40b and 40c to the connectors 18b and 18c, guide concave parts having the same structure may be provided to other connectors 18a and 18d.

As mentioned above, according to the present embodiment, the connectors 22b and 22c, which are to be connected to the connectors 18b and 18c, are lead to the respective connecting positions by providing the guide concave parts 40b and 40c providing the width direction guide surfaces and the raised portions 24b and 24c on the rear surface 14 of the housing of the monitor device 10. Accordingly, the connection connectors 22b and 22c can be accurately guided to the connecting positions by merely placing the connection connectors 22b and 22c inside the guide concave parts 40b and 40c and moving them toward the connectors 18b and 18c, thereby avoiding a problem such as bending of pins due to forced insertion with misalignment. Because the guide concave parts 40b and 40c and the raised portions 24b and 24c are integrally formed with the plastic mold housing 12 so as to be portions of the housing 12, there is no need to add any special parts that provide a guide function, thereby avoiding an increase in the manufacturing cost of the monitor device 10.

In the present embodiment, a distance between both side surfaces 42b and 42c of the guide concave parts 40b and 40c is set slightly larger than the corresponding connection connector. However, the distance between the both side surfaces 42b and 42c may be set larger at a position remote from the connector and gradually reduced as it goes close to the connector so that the distance becomes slightly larger than the width of the connector at a position slightly before the connecting position at which the connection connector is connected to the connector.

FIG. 10 is a view illustrating a state where the connection connectors 22a, 22b, 22c and 22d are connected to the connectors 18a, 18b, 18c and 18d illustrated in FIG. 2, respectively. The connectors 18a, 18b, 18c and 18d do not appear in the figure because they are hidden by the connection connectors 22a, 22b, 22c and 22d. Because the width direction guide surfaces and the height direction guide surfaces according to the above-mentioned embodiment are provided, even when the connectors 18a, 18b, 18c and 18d cannot be visually recognized, the connection connectors 22a, 22b, 22c and 22d can be easily connected to the connectors 18a, 18b, 18c and 18d so as to apply a cable wiring connection to the monitor device 10.

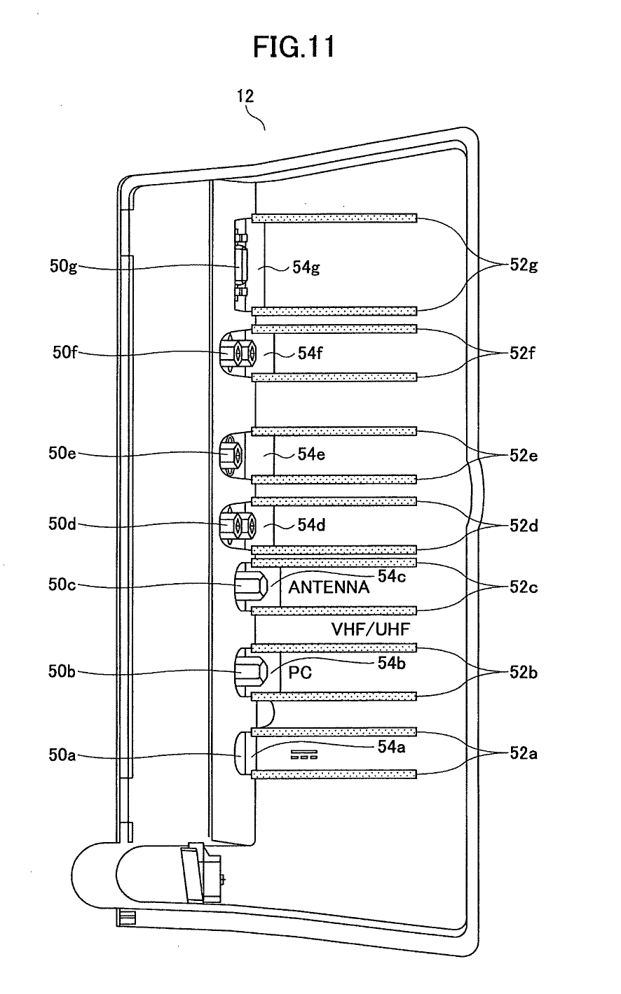

The guide function according to the above-mentioned first and second embodiments can be applied to a case where connectors are provided on the side surface of the housing. FIG. 11 is a view illustrating a part of the side surface of the housing in which connectors are provided.

In the example shown in FIG. 11, guide molds 52a-52g and raised portions 54a-54g are provided to the connectors 50a-50g provided on the side surface of the housing 12 of the monitor device 10, respectively.

Similar to the guide molds 20a-20d illustrated in FIG. 2, the guide molds 52a-52g provide width direction guide surfaces for guiding the connection connectors 50a-50g in a direction of width, respectively. Additionally, Similar to the raised portions 24a-24d illustrated in FIG. 2, the raised portions 54a-54g provide height direction guide surfaces for guiding the connectors 50a-50g in a direction of height.

Because the guide molds 52a-50d and the raised portions 54a-54g are provided, the connection connectors (not illustrated in the figure) can be easily guided to the positions of the connectors 50a-50g and easily connected to the connectors 50a-50g, respectively.

A description will be given of a structure according which a type of a connector can be easily recognized even when the connector cannot be recognized visually. According to the above-mentioned first and second embodiments, if, for example, the connector 18a cannot be recognized visually but an approximate position of the connector 18a is found, the connection connector 22a can be moved to the connecting position of the connector 18a placing the connection connector 22a between the guide projection parts or inside the guide concave part and moving toward the connector 18a. However, because the monitor device 10 is equipped with four connectors 18a, 18b, 18c and 18d, if the connectors on the monitor device 10 cannot be recognized visually, it is difficult to identify which guide projection part or guide concave part corresponds to a connector to be connected. Thus, even in a case where the connectors cannot be recognize visually, the connectors 18a, 18b, 18c and 18d are caused to be identified by using the structure explained below.

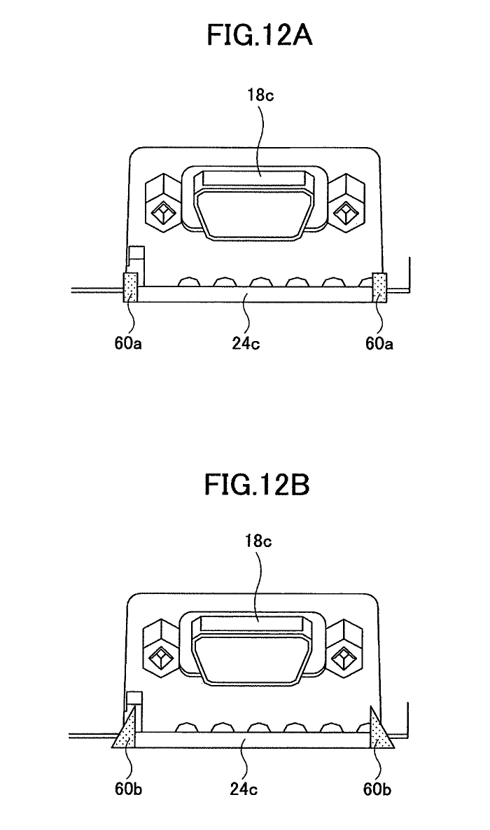

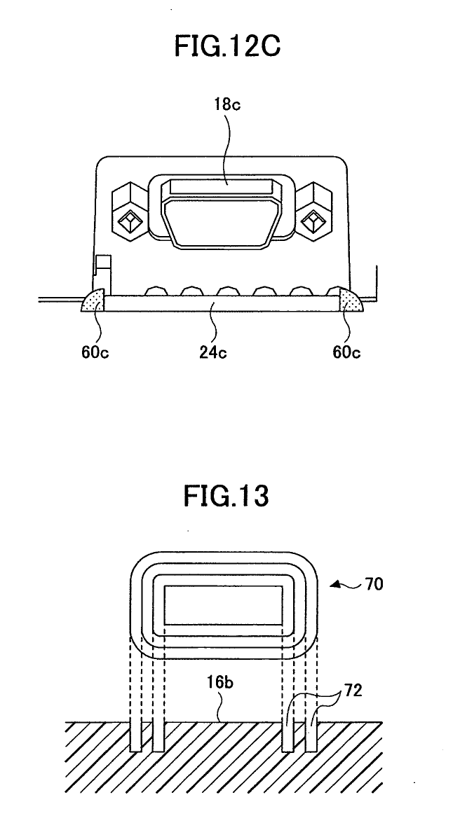

First, when a pair of guide projection parts (guide molds or metal plate guide parts) are provided as in the first embodiment, by changing the shapes of top parts of the guide projection parts as illustrated in FIGS. 12A, 12B and 12C, each of the guide projection parts can be identified as to which connector corresponds to the guide projection part concerned by touching the top parts by a finger. The guide projection part 60a illustrated in FIG. 12A has a rectangular cross-section. The guide projection part 60b illustrated in FIG. 12B has a triangular cross-section. The guide projection part 60c illustrated in FIG. 12C has a fan-shaped cross-section (¼ of a circle).

For example, if the guide projection part 60a having a rectangular cross-section is used as a guide projection part corresponding to the connector 18a, the guide projection part 60b having a triangular cross-section is used as a guide projection part corresponding to the connector 18b, and the guide projection part 60c having a fan-shaped cross-section is used as a guide projection part corresponding to the connector 18c, the shape of each of the guide projection parts can be identified by touching by a finger and recognize which connector corresponds to the identified guide projection part. In this case, when connecting, for example, the connection connector 20c to the connector 18c, first identifying a pair of guide projection parts 60c having the fan-shaped cross-section by touching the guide projection pats by a finger tip, and placing the connection connector 20c between the identified guide projection parts. Then, by moving the connection connector 20c along the guide projection parts 60c having the fan-shaped cross-section, the connection connector 20c is guided by the guide projection parts having a fan-shaped cross-section and is lead to the connecting position of the connector 18c. There is no need to visually recognize the connector 18c in the above-mentioned operation, and the connector 22c can be connected to the connector 18c according to mere a feel of touching by a finger tip.

As mentioned above, a pair of guide projection parts are separately provided to each of the plurality of connectors 18a, 18b, 18c and 18d, and a pair of width direction guide surfaces correspond to the opposing side surfaces of the pair of guide projection parts projecting from the surface of the housing. The cross-sectional shape of each of the pair of guide projection parts corresponding to one of the plurality of connectors 18a, 18b, 18c and 18d is different from the cross-sectional shapes of the guide projection parts corresponding to other connectors from among the connectors 18a, 18b, 18c and 18d. Thereby, by identifying the cross-sectional shape of the guide protruding parts by touching by a finger tip, a type of a connector corresponding to the identified cross-sectional view can be identified.

Alternatively, a mark part of which shape can be varied may be provided to the bottom surface 16b of the concave part 16 between a pair of guide projection parts in the above-mentioned first embodiment. In the above-mentioned second embodiment, a mark part can be provided on the bottom surface of the guide concave part.

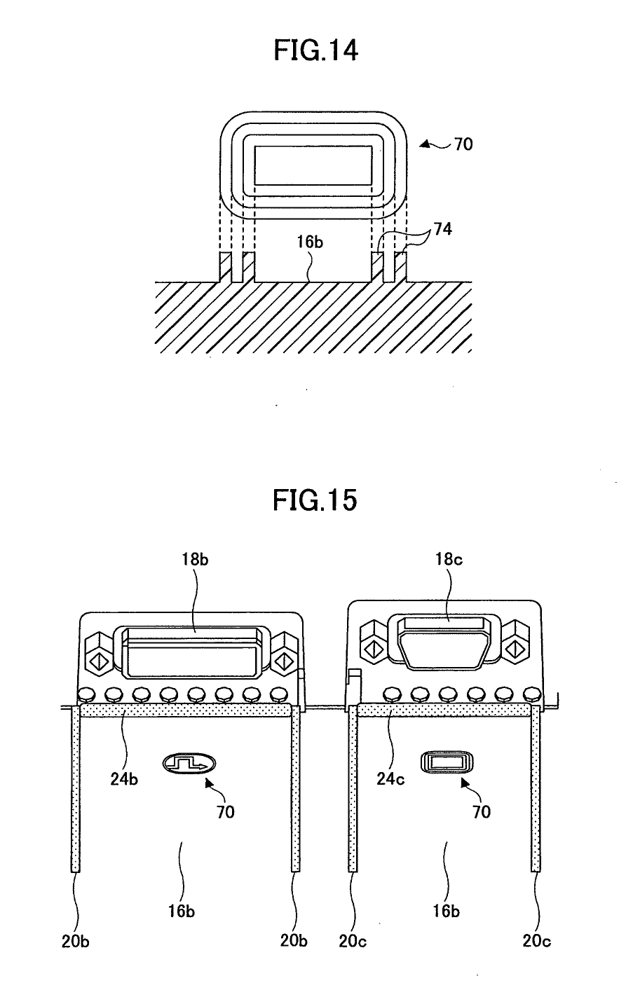

The mark part is provided by forming various shapes or patterns on the bottom surface 16b of the concave part 16. For example, the mark part 70 can be provided by forming a groove or recessed part 72 of a specific pattern on the bottom surface as illustrated in FIG. 13. Alternatively, the mark part 70 can be provided by forming a projection part 74 of a specific pattern on the bottom surface as illustrated in FIG. 14.

If the mark parts 70 provided to the plurality of connectors 18a, 18b, 18c and 18d have different shapes or patterns, by recognizing the mark part by touching the shape of the mark part by a finger tip, a type of a connector corresponding to the recognized mark part can be identified.

For example, by using generally used connector identification icons of a computer as illustrated in FIG. 15 for the shape and pattern of the mark part 70, a type of a connector can be identified by touching the mark part 70 by a finger tip.

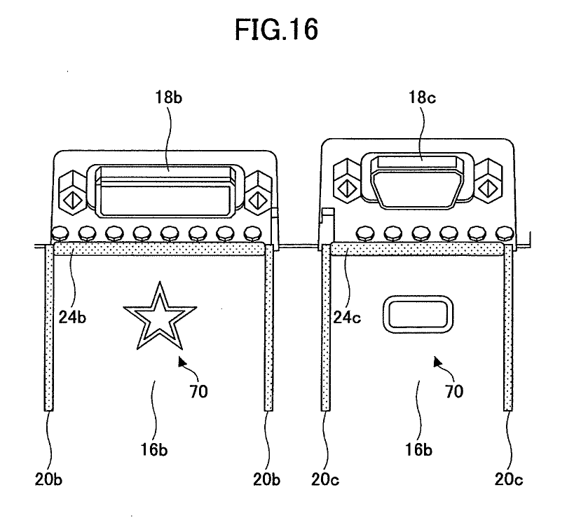

Moreover, by using simple shapes such as a star or a rectangle as illustrated in FIG. 16 for the shape and pattern of the mark part 70, a type of a connector can be identified by touching the mark part 760 by a finger tip. In this case, for example, it is previously determined that the star corresponds to the type of the connector 18b and the elongated rectangle corresponds to the type of the connector 18c.

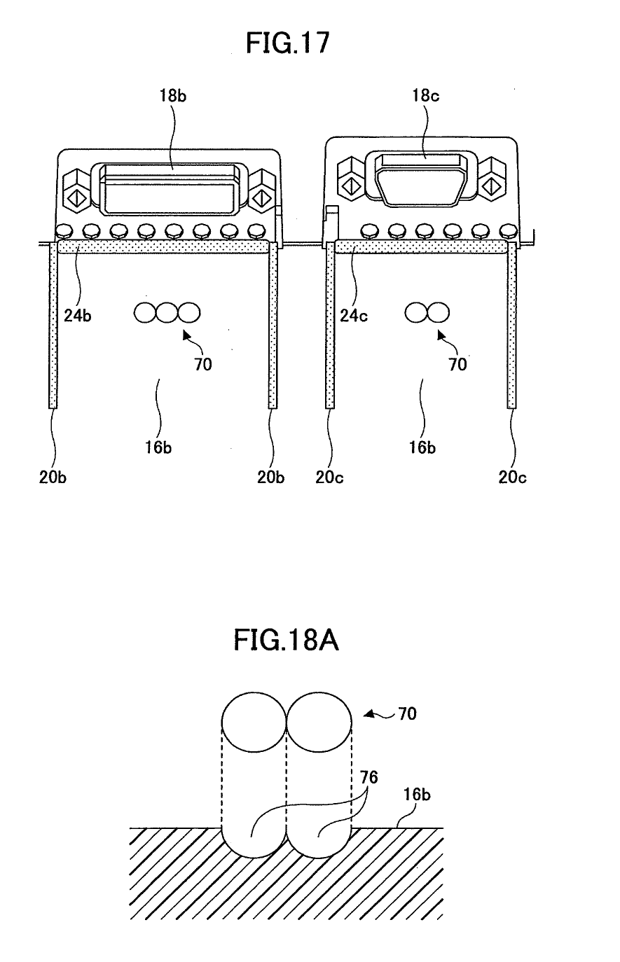

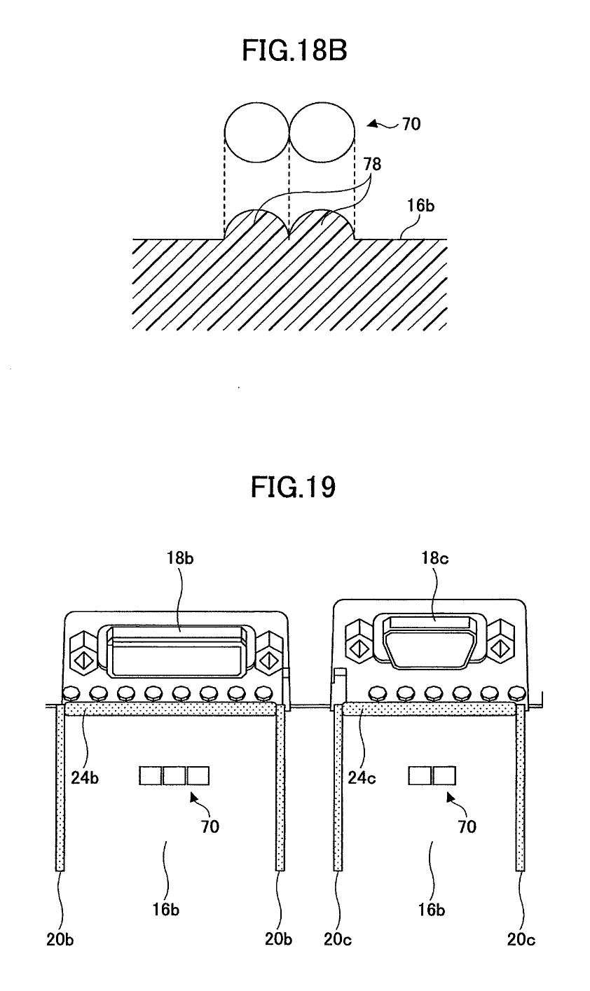

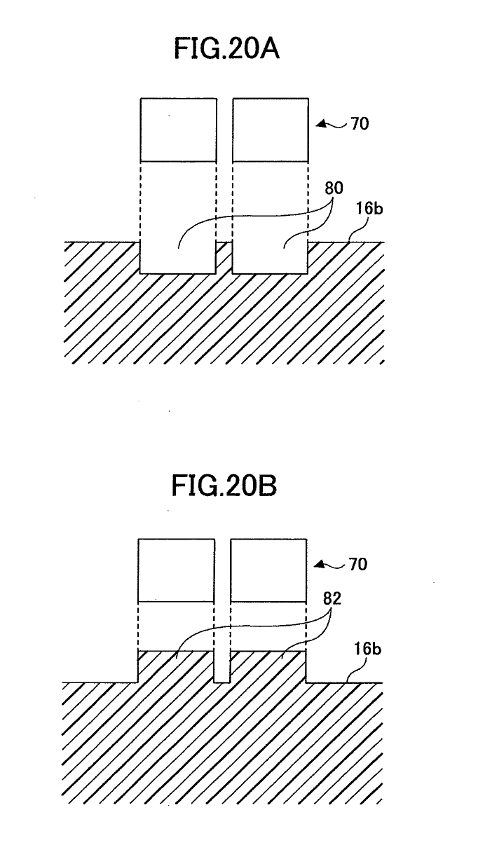

Alternatively, a type of a connector can be identified by a number of projection parts or recessed parts of a simple shape such as a circle or a square as a shape or pattern of the mark part 70. In this case, for example, it is previously determined that if the number of projection parts or the recessed parts of the mark part 70 is three (3), the mark part 70 corresponds the type of the connector 18b, and if the number of projection parts or the recessed parts of the mark part 70 is two (2), the mark part 70 corresponds the type of the connector 18c. FIG. 17 is a view indicating an example where a type of a connector is identified by a number of circles formed as the mark part 70. FIG. 18A is an illustration indicating the recessed parts 76 of circles forming the mark part 70. FIG. 18B is an illustration indicating the projection parts 78 of circles forming the mark part 70. FIG. 19 is a view indicating an example where a type of a connector is identified by a number of squares formed as the mark part 70. FIG. 20A is an illustration indicating the recessed parts 80 of squares forming the mark part 70. FIG. 20B is an illustration indicating the projection parts 82 of squares forming the mark part 70.

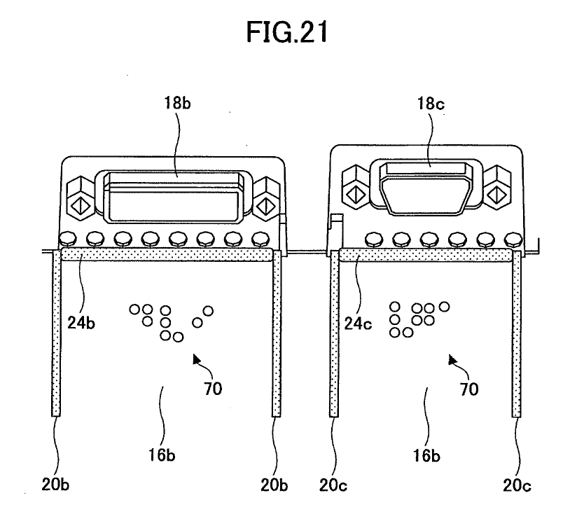

Moreover, Braille notation may be used as the mark part 70 as illustrated in FIG. 21. In this case, the Braille notation itself expresses the type of the connector. In FIG. 21, the Braille of the mark part 70 used for the connector 18b expresses “DIV” and the Braille of the mark part 70 used for the connector 18c expresses “VGA”.

All examples and conditional language recited herein are intended for pedagogical purposes to aid the reader in understanding the principles of the invention and the concepts contributed by the inventor to furthering the art, and are to be construed a being without limitation to such specifically recited examples and conditions, nor does the organization of such examples in the specification relates to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. An electronic apparatus equipped with a connector, comprising:
the connector provided to a surface of a housing; and
a guide part configured to guide a connection connector, which is to be connected to said connector, to a connecting position,
wherein said guide part includes a pair of width direction guide surfaces and a height direction guide surface, the width direction guide surfaces guiding said connection connector to the connecting position with respect to a direction of width of said connector by sandwiching said connection connector therebetween in the direction of width, said height direction guide surface guiding said connection connector to the connecting position with respect to a direction of height of said connector in a state where said connection connector is in contact with said height direction guide surface.

2. The electronic apparatus as claimed in claim 1, wherein said pair of width direction guide surfaces are side surfaces of a guide projection part projecting from the surface of the housing.

3. The electronic apparatus as claimed in claim 1, wherein said housing is a plastic mold product, and said guide projection part is a plastic part integrally formed with said housing.

4. The electronic apparatus as claimed in claim 2, wherein said guide projection part is a part of a metal plate part provided in said housing, and is projecting to outside said housing through an opening provided in said housing.

5. The electronic apparatus as claimed in claim 1, wherein a distance between said pair of width direction guide surfaces is gradually reduced toward said connector.

6. The electronic apparatus as claimed in claim 1, wherein said pair of width direction guide surfaces are opposing side surfaces of guide concave parts formed on the surface of said housing.

7. The electronic apparatus as claimed in claim 6, wherein said housing is a plastic mold product, and said guide concave part is a recess formed simultaneously with formation of said housing.

8. The electronic apparatus as claimed in claim 1, wherein said connector is provided at a position on a rear surface of a side surface of said housing, the position being not viewed from a front side of said electronic apparatus.

9. The electronic apparatus as claimed in claim 1, wherein a plurality of said connectors are provided and said guide part is provided to each of said plurality of connectors;
said pair of width direction guide surfaces are opposing surfaces of a pair of guide projection parts projecting from the surface of said housing; and
a cross-sectional shape of each of said pair of guide projection parts corresponding to one of said plurality of connectors is different from a cross-sectional shape of each of said pair of guide projection parts corresponding to other connectors from among said plurality of connectors.

10. The electronic apparatus as claimed in claim 1, wherein a plurality of said connectors are provided, and said guide part is separately provided to each of said connectors; and
a mark part to identify a type of each of said connectors is provided near each of said plurality of connectors.

11. The electronic apparatus as claimed in claim 10, wherein a shape of said mark part corresponding to one of said plurality of connectors is different from shapes of said mark parts corresponding to other connectors from among said plurality of connectors.

12. The electronic apparatus as claimed in claim 11, wherein each of said mark parts has a shape indicating a shape expressing a type of one of said connectors.

13. The electronic apparatus as claimed in claim 11, wherein each of said mark parts is a recessed part or a projection part expressing a shape corresponding to a type of one of said connectors.

14. The electronic apparatus as claimed in claim 11, wherein each of said mark part includes recessed parts or projection parts of which number corresponds to a type of one of said connectors.

15. The electronic apparatus as claimed in claim 11, wherein each of said mark parts contains Braille expressing a type of one of said connectors.
